(19) United States
(12) Patent Application Publication
(10) Pub. No.: US 2006/0159183 A1
(43) Pub. Date: Jul. 20, 2006

(54) Receiver and packet formatter for decoding an atsc dtv signal

(75) Inventors: Vasanth R. Gaddam, Tarrytown G, NY (US); Dagnachew Birru, Yorktown Heights, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKIJKLE PHILLIPS ELECTRONICS N.V.

(21) Appl. No.: 10/562,540

(22) PCT Filed: Jun. 28, 2004
(86) PCT No.: PCT/IB04/51037

§ 371 Date: Dec. 28, 2005

(30) Foreign Application Priority Data
Jun. 30, 2003 (US) 60483792

(51) Int. Cl. H04N 7/12

(52) U.S. Cl. 375/240.26

(57) ABSTRACT

A packet formatter for use in a television receiver capable of receiving a dual bitstream signal comprising a standard stream compatible with the Advanced Television Systems Committee (ATSC) standard and a robust stream. The packet formatter comprises: 1) a first processing block capable of receiving the dual bitstream signal and removing therefrom header bits and parity bits associated with the robust stream to thereby produce a first output signal; and 2) a second processing block capable of receiving the first output signal and removing therefrom duplicate bits associated with the robust stream to thereby produce a second output signal that is output from a data path output of the packet formatter.

The present invention relates generally to television receivers and, in particular, to a receiver architecture and packet formatter for decoding a dual bit-stream ATSC Digital Television (DTV) signal.

The Advanced Television Systems Committee (ATSC) has adopted 8 Vestigial Sideband (8-VSB) as the standard for terrestrial broadcasting of Digital Television (DTV) signals. In order to improve system performance and to satisfy the demand of broadcasters for flexibility in terms of carrying multiple bit-streams, Philips Research USA has proposed a transmission system for embedding a robust bit-stream in the existing standard bit-stream in a backward compatible manner. The system is disclosed in U.S. patent application Ser. No. [Docket No. 703910], entitled “Apparatus and Method for Generating Robust ATSC 8-VSB Bit-Streams,” and U.S. patent application Ser. No. 09/781,486, entitled “System and Method for Sending Low Rate Data on a Packet Basis in an 8-VSB Standard Data Packet Stream.” The disclosures of application Ser. Nos. [Docket No. 703910] and 09/781,486 are hereby incorporated by reference into the present application as if fully set for herein. The new transmission system has the ability to trade off data rates for robustness, the option to include a backward-compatible parity byte generator, the option to choose from different modulation schemes, and the like.

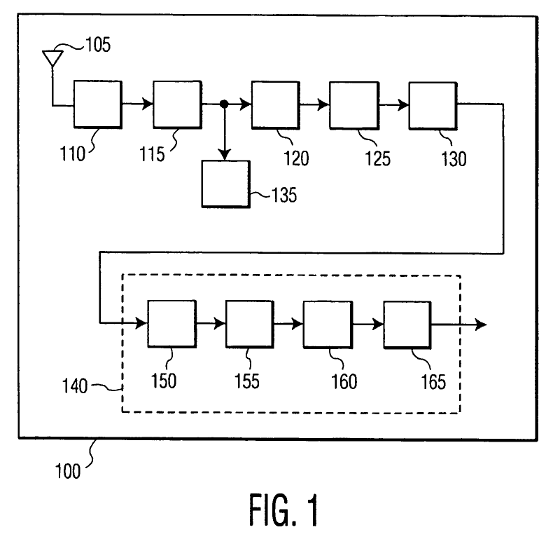

FIG. 1 is a block diagram illustrating conventional eight level vestigial sideband (8-VSB) receiver 100 according to an exemplary embodiment of the prior art. Conventional 8-VSB receiver 100 comprises antenna 105, tuner 110, filter and synchronization detector block 115, NTSC rejection filter 120, equalizer 125, phase tracker 130, and synchronization and timing block 135. Receiver 100 also comprises a forward error correction section 140. FEC section 140 comprises trellis decoder 150, data de-interleaver 155, Reed-Solomon (RS) decoder 160, and data de-randomizer 165. Receivers from different manufacturers vary from this basic architecture, especially in the carrier recovery section (i.e., tuner 110), the timing recovery section (i.e., synchronization and timing block 135), and the equalizer section. However, the forward error correction (FEC) section of receiver 100 is typical of most receivers.

Tuner 110 receives an incoming RF signal from antenna 105. Tuner 110 down-converts the received RF signal to an intermediate frequency (IF) signal. Filter and synchronization detector block 115 filters the IF signal and converts the IF signal to digital form. At the output of filter and synchronization detector block 115, the detected signal comprises a stream of data symbols, where each symbol signifies a level in an eight (8) level constellation. Synchronization and timing block 135 generates synchronization and timing signals from the symbol stream. NTSC rejection filter 120 filters the symbol stream. The filtered output from NTSC rejection filter 120 undergoes equalization in equalizer 125 and phase tracking in phase tracker 130. Trellis decoder 150 trellis decodes the recovered encoded data symbols from phase tracker 130 and data de-interleaver 155 de-interleaves the decoded data bytes. RS decoder 160 decodes the de-interleaved data bytes. Finally, the output of RS decoder 160 is de-randomized by data de-randomizer 165 to produce the MPEG compatible data packets that were originally transmitted to conventional 8-VSB receiver 100.

Trellis decoder 150 comprises 12 trellis decoder blocks in parallel, where each trellis decoder sees every 12^{th} data symbol. The 12 trellis decoder blocks receive symbols from phase tracker 130 and decode the data symbols to get back the pre-coded and the convolutional encoded bits. The decoded bits are then grouped into bytes and passed on to data de-interleaver 155. Data de-interleaver 155 comprises a convolutional de-interleaver circuit that performs the inverse operation of the transmitter convolutional interleaver. The output of convolutional data de-interleaver 155 is sent to the (207 bytes, 187 bytes) t=10 RS decoder 160. RS decoder 160 is capable of correcting a maximum of 10 byte errors per packet. RS decoder 160 then passes the corrected data packets (without the parity bytes) to data de-randomizer 165. De-randomizer 165 reverses the operation performed by the data randomizer in the transmitter, thereby recovering the transport stream packets. De-randomizer 165 is synchronized with the field synchronization signals.

The new flexible transmission system proposed by Philips Research USA is capable of simultaneously transmitting two bit-streams in the same physical channel. The new transmitter includes some signal parameters, such as MODE, TR, NRP, NRS, and the like, that can be modified by the broadcaster. MODE defines the type of modulation used for the new stream, TR defines the additional coding rate used, NRP defines the number of new stream packets per field, and NRS defines the presence of a backward-compatible parity byte generator (BCPBG). Any receiver designed to decode the signals transmitted by a new ATSC transmitter must have a mechanism to identify and track the symbols and bytes of different bit-streams. Such a receiver should also be capable of decoding the two bit-streams optimally within the implementation constraints. These requirements mean that the conventional architecture of receiver 100 in FIG. 1 must be modified to include new control and signal processing blocks.

To meet the requirements of the new dual bit-stream transmitters, the present invention introduces a new ATSC receiver that includes a new receiver packet formatter, a new robust data de-interleaver, and a new data de-randomizer. A receiver according to the principles of the present invention may be implemented in hardware, as well as software (i.e., digital signal processor embodiment). The dual stream VSB receiver can decode a standard bit-stream and a robust stream transmitted by a new ATSC transmitter. The dual stream VSB receiver also can decode a conventional ATSC signal transmitted by an existing transmitter. The new receiver also takes advantage of the pseudo 2-VSB bit-stream to improve the performance of the 8-VSB bit-stream.

To address the above-discussed deficiencies of the prior art, it is a primary object of the present invention to provide a packet formatter for use in a television receiver capable of receiving a dual bitstream signal comprising a standard stream compatible with the Advanced Television Systems Committee (ATSC) standard and a robust stream. According to an advantageous embodiment of the present invention, the packet formatter comprises: 1) a first processing block capable of receiving the dual bitstream signal and removing therefrom header bits and parity bits associated with the robust stream to thereby produce a first output signal; and 2) a second processing block capable of receiving the first output signal and removing therefrom duplicate bits associated with the robust stream to thereby produce a second output signal that is output from a data path output of the packet formatter.

According to one embodiment of the present invention, the packet formatter passes bytes associated with the standard stream to the data path output of the packet formatter after delaying the standard stream bytes by a predetermined delay time.

According to another embodiment of the present invention, the packet formatter comprises a third processing block capable of determining the locations of the parity bits in the robust stream.

According to still another embodiment of the present invention, the third processing block is further capable of determining the locations of the header bits in the robust stream.

According to yet another embodiment of the present invention, the third processing block comprises a look-up table.

According to a further embodiment of the present invention, the packet formatter generates and output packet identification information used by subsequent processing blocks following the packet formatter.

It is another primary object of the present invention to provide a data de-randomizer for use in a television receiver capable of receiving a dual bitstream signal comprising a standard stream compatible with the Advanced Television Systems Committee (ATSC) standard and a robust stream. According to an advantageous embodiment of the present invention, the data de-randomizer comprises: 1) a standard de-randomizer capable of de-randomizing bytes associated with the standard stream; and 2) a robust de-randomizer capable of de-randomizing bytes associated with the robust stream.

Before undertaking the DETAILED DESCRIPTION OF THE INVENTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

For a more complete understanding of the present invention, and the advantages thereof, reference is now made to the following descriptions taken in conjunction with the accompanying drawings, wherein like numbers designate like objects, and in which:

FIG. 1 illustrates a conventional eight level vestigial sideband (8-VSB) receiver according to an exemplary embodiment of the prior art;

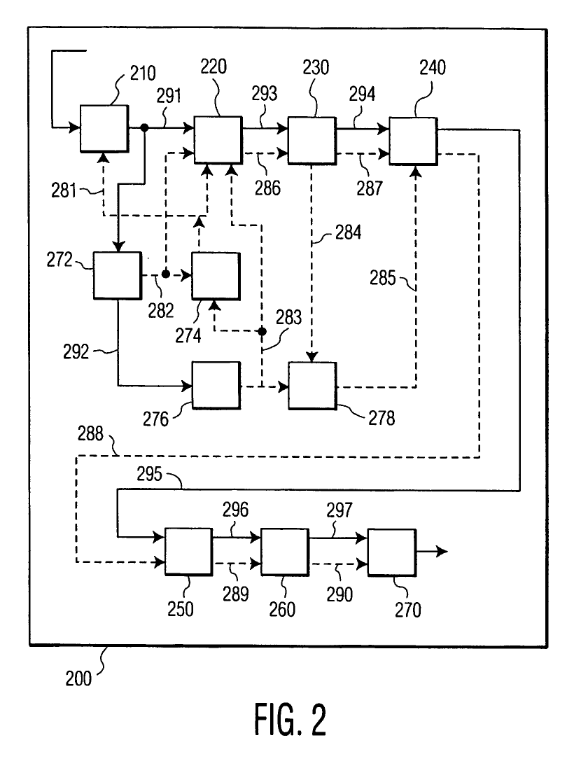

FIG. 2 illustrates the forward error connection (FEC) block of an eight level vestigial sideband (8-VSB) receiver according to an exemplary embodiment of the present invention;

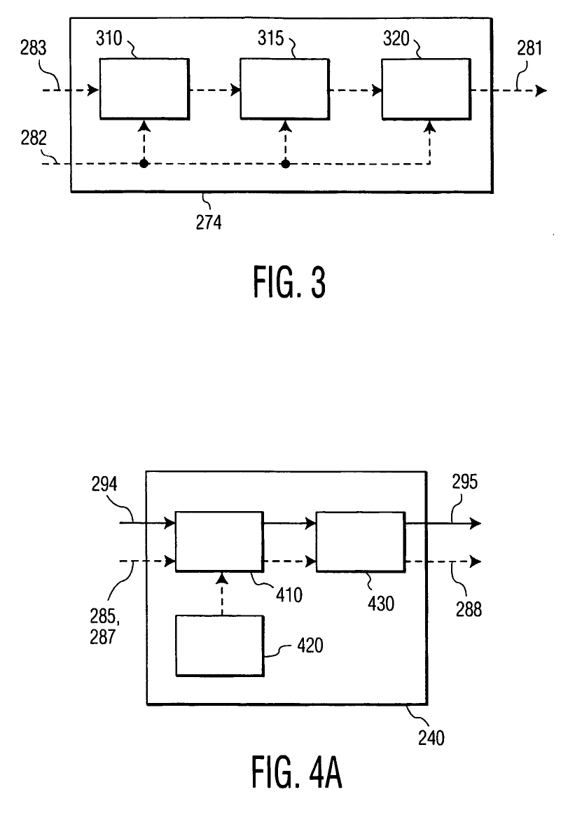

FIG. 3 is a block diagram illustrating in greater detail the generate td_hd_sd block of the 8-VSB receiver according to an exemplary embodiment of the present invention;

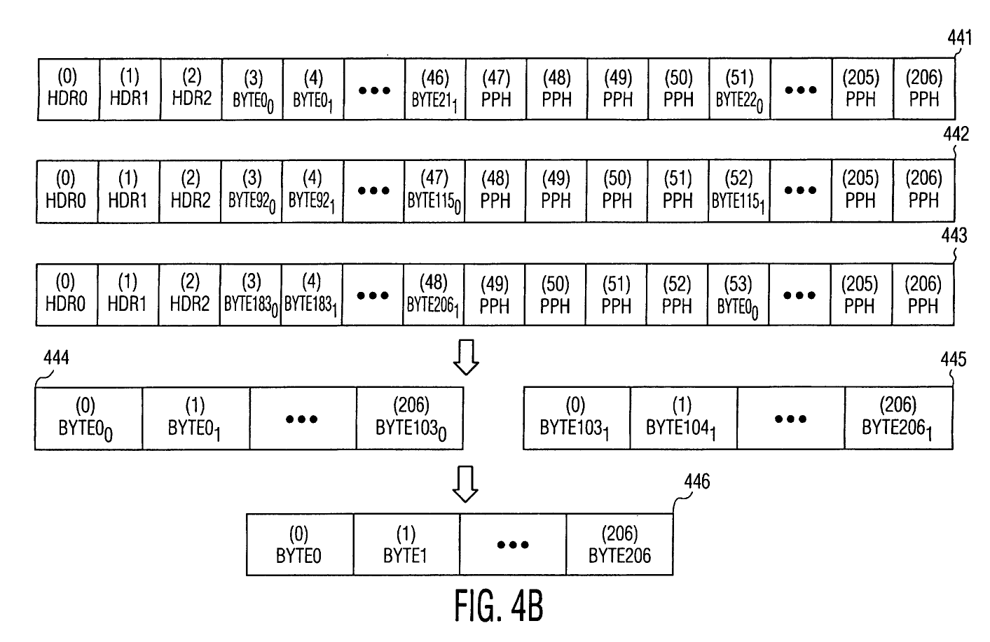

FIG. 4A is a block diagram illustrating in greater detail the packet formatter block of the 8-VSB receiver according to an exemplary embodiment of the present invention;

FIG. 4B is a block diagram illustrating the operation (for one particular set of parameters) of the remove header and parity place holder processing block in the packet formatter block according to an exemplary embodiment of the present invention;

FIG. 4C is a block diagram illustrating the operation of the remove duplicate bits processing block in the packet formatter block according to an exemplary embodiment of the present invention;

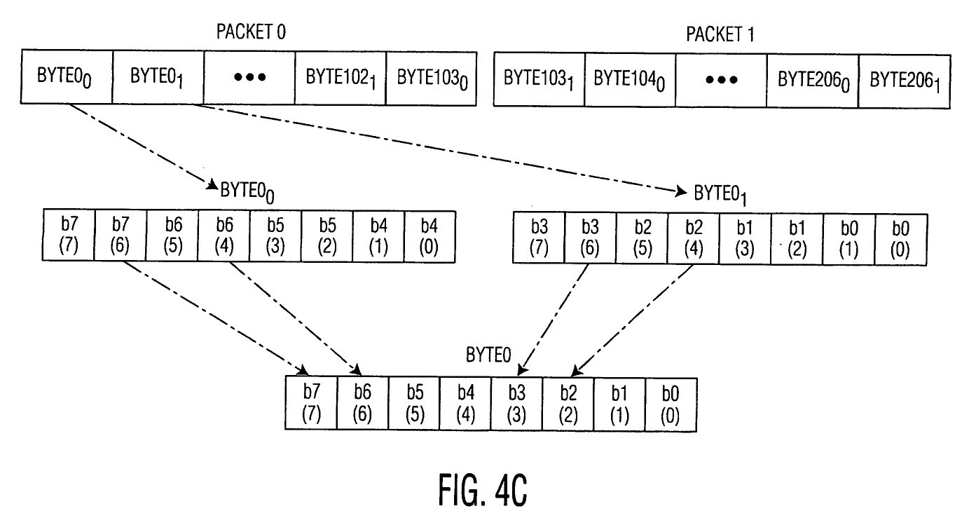

FIG. 5 is a logic diagram illustrating in greater detail the robust de-interleaver block of the 8-VSB receiver according to an exemplary embodiment of the present invention;

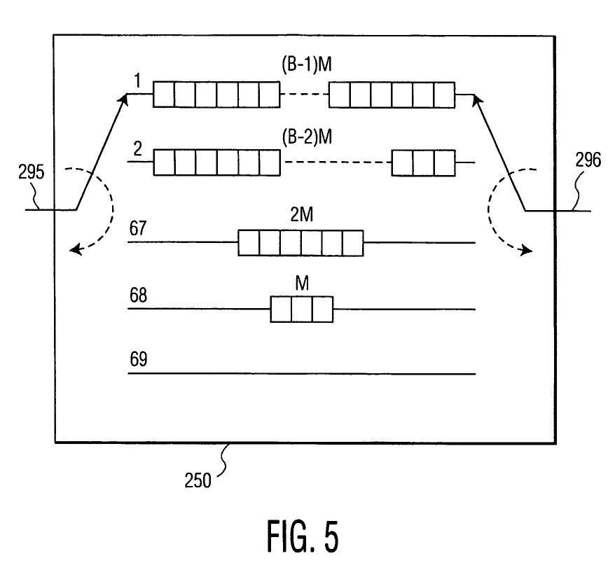

FIG. 6 is a block diagram illustrating in greater detail the robust de-interleaver block of the 8-VSB receiver according to an exemplary embodiment of the present invention; and

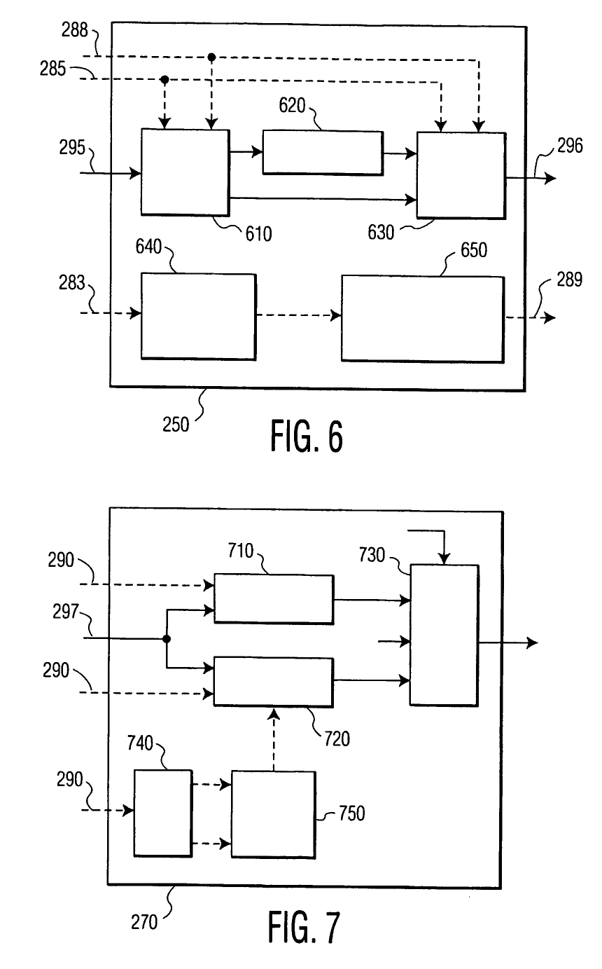

FIG. 7 illustrates in greater detail the de-randomizer block of the 8-VSB receiver according to an exemplary embodiment of the present invention.

FIGS. 2 through 7, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged ATSC digital television receiver.

FIG. 2 is a block diagram illustrating selected portions of the forward error connection (FEC) section of eight level vestigial sideband (8-VSB) receiver 200 according to an exemplary embodiment of the present invention. The receiver front-end of receiver 200 is similar to the receiver front-end of conventional receiver 100 in FIG. 1 (i.e., tuner 110, filter and synchronization detector 115, NTSC rejection filter 120, equalizer 125, etc.). The only receiver front-end component shown in FIG. 2 is equalizer 210. For the sake of brevity and clarity, a description of the rest of the front-end of the new 8-VSB receiver 200 is not repeated here.

The forward error correction (FEC) section of receiver 200 comprises trellis decoder 220, convolutional de-interleaver 230, packet formatter 240, robust de-interleaver 250, Reed-Solomon (RS) decoder 260, and de-randomizer 270. The FEC section of receiver 200 further comprises synchronization detector 272, generate td_hd_sd block 274, decode synchronization header block 276, and generate ps_hd_sd block 278. The FEC section of receiver 200 is capable of decoding signals transmitted by the new dual bit-stream VSB transmitter. As FIG. 2 illustrates, most of the functional blocks in the signal processing path (or data path) are derived from the existing architecture of prior art receiver 100. The functionality of these blocks is enhanced to support the decoding of the two bit-streams. In addition to this, new signal processing blocks are added to process robust bit-stream packets.

The blocks in the control path are used to identify and track the symbols and bytes that belong to different bit-streams. The blocks in the control path are synchronization detector 272, generate td_hd_sd block 274, decode synchronization header block 276, and generate ps_hd_sd block 278. The blocks in the data path are trellis decoder 220, convolutional de-interleaver 230, packet formatter 240, robust de-interleaver 250, RS decoder 260 and de-randomizer 270. In FIG. 2, control signal paths 281-290 are shown as dotted lines and data paths 291-297 are shown as solid lines. It is noted that equalizer 210, trellis decoder 220, and synchronization detector 272 operate on the symbol clock, while the rest of the functional blocks in the data path operate on the byte clock. Synchronization detector 272 detects the field synchronization signal and the segment synchronization signal. All of the functional blocks in FIG. 2 are synchronized with the field synchronization signal and the segment synchronization signal.

Decode synchronization header block 276 decodes the field synchronization header information to extract the MODE, TR, NRS, and NRP parameters, which are output on control signal path 283. The decoded MODE, TR, NRP and NRS parameters are sent over control path signal 283 to generate td_hd_sd block 274, trellis decoder 220, and generate ps_hd sd block 278. Decode synchronization header block 276 also determines if the received signal is transmitted by a new dual bit-stream ATSC transmitter or a prior art transmitter.

FIG. 3 illustrates generate td_hd_sd block 274 of 8-VSB receiver 200 according to an exemplary embodiment of the present invention. Generate td_hd_sd block 274 comprises generate hd_sd_in block 310, convolutional bit interleaver 315, and trellis interleaver 320. The functionality of these blocks is very similar to the corresponding blocks in the transmitter. Generate td_hd_sd block 274 generates the td_hd_sd control signal on control signal path 281 for use by trellis decoder 220 and equalizer 210. The td_hd_sd control signal changes per symbol and is used to determine if the symbol at equalizer 210 and trellis decoder 220 belongs to a standard stream or a new dual bit-stream. The td_hd_sd control signal is synchronized with the field synchronization signal.

Generate hd_sd_in block 310 generates control information at packet level based on the MODE, TR, NRP and NRS parameters received on control signal path 283. The output of generate hd_sd_in block 310 is set to Logic 1 if the packet belongs to the new stream (NS) and is equal to Logic 0 if the packet belongs to a standard stream (SS). Generate hd_sd_in block 310 only starts when back-end lock is obtained and is synchronized with the field synchronization and the segment synchronization signals.

Convolutional bit interleaver 315 is similar to the convolutional byte interleaver specified in the standard, except that the memory element is one bit instead of one byte. Convolutional bit interleaver 315 tracks bytes belonging to the two bit-streams through the convolutional interleaver in the data path. Convolutional bit interleaver 315 interleaves the output of generate hd_sd_in block 310.

Trellis interleaver 320 implements the 12-symbol trellis interleaver circuit. The output of trellis interleaver is the td_hd_sd control signal on control signal path 281. The td_hd-sd control signal is greater than 0 (i.e., 1, 2 or 3) when trellis decoder 220 input symbol (or equalizer 210 output symbol) belongs to a new stream (NS). The td_hd-sd control signal is equal to 0 when trellis decoder 220 input symbol belongs to a standard stream (SS). Equalizer 210 uses the td_hd-sd control signal to get a better estimate of the symbol and trellis decoder 220 uses the td_hd-sd control signal in metric calculations. The output of generate td_hd_sd block 274 should be perfectly synchronized with the input to trellis decoder 220. The output should be generated by the time the first valid data symbol appears at the input of trellis decoder 220.

Generate ps_hd_sd block 278 generates the ps_hd_sd control signal on control signal path 285. Generate ps_hd_sd block 278 is similar to generate hd_sd_in block 310 except that generate ps_hd_sd block 278 is synchronized with convolutionade-interleaver 230 output synchronization signal. Generate ps_hd_sd block 278 is reset on each field based on the de-interleaver 230 start/reset signal. The ps_hd_sd control signal is used to control the processing of the blocks following the convolutional de-interleaver 230 in the data path.

Trellis decoder 220 is based on the Viterbi algorithm and is used to decode the convolutional encoded symbols. Trellis decoder 220 receives the equalized symbols from equalizer 210, receives the MODE, TR, NRP and NRS control signals on control signal path 283 from decode synchronization header block 276, and receives the td_hd_sd control signal from generate td_hd_sd block 274 on control signal path 281. Trellis decoder 220 uses soft decision decoding to decode the received symbols. The trellis decoder of conventional (prior art) receiver 100 has to decode only the bits corresponding to the rate-⅔ trellis encoded symbols. In new dual bit-stream receiver 200, trellis decoder 220 must be able to decode the standard bit-stream bits, as well as the robust bit-stream bits. The robust bit-stream bits are encoded using different encoding schemes, such as Pseudo 2-VSB, E-VSB, and the like. Most of the performance gain for the robust stream is obtained through the robust coding. Trellis decoder 220 decodes all bit-streams without any loss in performance.

As in a conventional receiver, trellis decoder 220 comprises 12 trellis decoder circuits in parallel, where each decoder sees every 12^{th} symbol. Trellis decoder 220 uses the td_hd_sd control signal to determine if the received symbol is encoded as a standard stream symbol or as a robust stream symbol. Trellis decoder 220 uses different metric calculation methods for different modes of operation. The decoded bits are assembled into bytes and are then passed on to convolutional de-interleaver 230.

Convolutional de-interleaver 230 performs the same function as a conventional de-interleaver in a prior art receiver. Convolutional de-interleaver 230 receives data and control signals from trellis decoder 220 via data path 293 and control signal path 286. Convolutional de-interleaver 230 de-interleaves the standard stream (SS) bytes and the new stream (NS) bytes using the same algorithm (i.e., convolutional de-interleaver 230 does not differentiate between SS bytes and NS bytes). The de-interleaved data and the delayed control signals are then sent to packet formatter 240 via data path 294 and control signal path 287, respectively. The control signals from convolutional de-interleaver 230 are also sent to generate ps_hd_sd block 278 via control signal path 284.

FIG. 4A is a block diagram illustrating in greater detail packet formatter 240 of 8-VSB receiver 200 according to an exemplary embodiment of the present invention. Packet formatter 240 comprises remove header and parity place holder (PPH) processing block 410, PPH calculator/look-up table (LUT) processing block 420, and remove duplicate bits processing block 430. Packet formatter 240 in receiver 200 performs the inverse operation of the transmitter packet formatter (T×PF). In the ATSC transmitter, the transmitter packet formatter duplicates the bits of the robust packets, so that the information bits are always placed in the LSB positions (6, 4, 2, 0) for the trellis encoder in the transmitter. Because of this transformation, each robust information packet is converted into two robust packets. In order to satisfy backward-compatibility requirements (i.e., when NRS=1), the T×PF also inserts 23 additional bytes in each new robust packet after the duplication step.

Receiver packet formatter 240 (R×PF) is placed after convolutional de-interleaver 230 in the data path. TABLE 1 shows the functionality of packet formatter 240 for different combinations of MODE, TR and NRS parameters. New stream (NS) refers to either the robust bit-stream (when MODE=2 or 3) or the embedded bit-stream (when MODE=1). Packet formatter 240 only reformats bytes and packets belonging to the new stream (NS). The bytes belonging to the standard stream (SS) are just passed through with an appropriate delay. Packet formatter 240 also generates control information for packet identification to be used by the subsequent processing blocks in the data path. The following description discusses processing for MODE=2 or 3. The new stream is made up of robust information (RI) packets and robust NULL (RN) packets. The ps_hd_sd control signal determines if the bytes belong to the standard stream (SS) or to the new stream (NS).

TABLE 1
Packer Formatter 240 Functionality for
Different Parameter Combinations

| MODE | TR | NRS | Functionality |
|---|---|---|---|
| 0 | 0/1 | 0/1 | Pass through |
| 1 | 0 | 0 | Convert 2 NS packets to 1 robust |
| | | | information packet and 1 embedded |
| | | | information packet |
| | 0 | 1 | Convert 9 NS packets to 4 robust |
| | | | information packets, 4 embedded |
| | | | information packets and 1 NULL packet |
| 2, 3 | 0 | 0 | Convert 2 NS packets to 1 robust |
| | | | information packets and 1 NULL packet |
| | 0 | 1 | Convert 9 NS packets to 4 robust |
| | | | information packets and 5 NULL packets |
| | 1 | 0 | Convert 4 NS packets to 1 robust |
| | | | information packet and 3 NULL packets |
| | 1 | 1 | Convert 9 NS packets to 2 robust |
| | | | information packets and 7 NULL packets |

When NRS=1, PPH calculator/LUT processing block 420 identifies the location of the additional parity bytes and header bytes inserted by the backward-compatible parity byte generator (BCPBG). Remove header and PPH processing block 410 then removes the additional parity bytes and header bytes. Remove duplicate bits processing block 430 then removes the duplicate bits from all the robust bytes.

FIG. 4B is a block diagram illustrating an exemplary operation of remove header and parity place holder (PPH) processing block 410 in packet formatter 240 according to one exemplary embodiment of the present invention. Remove header and PPH processing block 410 removes parity place holder (PPH) bytes and header (HDR) bytes from robust packet 441, robust packet 442, and part of robust packet 443 to produce packet 444 and packet 445. Then, remove duplicate bits processing block 430 removes duplicate bits from packet 444 and packet 445 to produce robust information (RI) packet 446.

FIG. 4B shows the operation for NRP=162 (1100). Remove header and PPH processing block 410 is only active when NRS=1. Remove header and PPH processing block 410 uses information from PPH calculator/LUT processing block 420 to determine if the incoming byte belongs to the data stream, to the additional header bytes, or to the BCPBG parity bytes. The first 3 bytes of an incoming robust packet are the additional header bytes and are therefore removed from the packet. The parity place holder (PPH) location number is dependent on the NS packet position in the frame. The PPH location number is compared with the incoming byte position within the packet. If the location number and the incoming byte position match, then the byte is dropped and the comparison moves on to the next position in the look-up table [LUT]. The LUT contains the PPH location numbers for different packet positions in the frame.

FIG. 4C is a block diagram illustrating the operation of remove duplicate bits processing block 430 in packet formatter 240 according to an exemplary embodiment of the present invention. Remove duplicate bits processing block 430 is invoked in all cases when MODE=2 or 3. After remove header and PPH processing block 410 removes the additional 3 header bytes and 20 parity bytes, the remaining bytes of packet 444 (Packet 0) and packet 445 (Packet 1) are sent to remove duplicate bits processing block 430. FIG. 4C shows the operation of remove duplicate bits processing block 430 for an exemplary case with TR=0. In this example, remove duplicate bits processing block 430 processes Packet 0 and Packet 1 by combining pairs of bytes (e.g., Byte 0₀ and Byte 0₁) to form one byte (Byte 0) by selecting the LSBs (bits 6, 4, 2, 0) from each pair of byte.

Next, remove duplicate bits processing block 430 groups the bytes thus formed (e.g., Byte 0) into a 207 byte robust information (RI) packet and sends each RI packet, along with the NULL packets, to the following blocks in the data-path. The NULL packets are made up of zero-valued bytes. The NULL packet headers are later modified by de-randomizer 270 so that they appear as NULL packets to the MPEG decoder. The order of the robust information packets and the NULL packets at the output of packet formatter 240 is shown in TABLE 2 for the case of NRS=1. This pattern repeats every 9 NS packets (i.e. 4 RI+5 NULL packets).

TABLE 2
Classification of Robust Packets Based
on Packet Number When NRS = 1

| Robust packet # mod 9 | Packet type at | Packet type at |
|---|---|---|
| (rob_pac_cnt) | Transmitter PF input | Receiver PF output |
| 0 | Robust Info (RI) | Place Holder (NULL) |
| 1 | Place Holder (NULL) | Place Holder (NULL) |
| 2 | Robust Info (RI) | Robust Info (RI) |
| 3 | Place Holder (NULL) | Place Holder (NULL) |
| 4 | Robust Info (RI) | Robust Info (RI) |
| 5 | Place Holder (NULL) | Place Holder (NULL) |
| 6 | Robust Info (RI) | Robust Info (RI) |
| 7 | Place Holder (NULL) | Place Holder (NULL) |
| 8 | Place Holder (NULL) | Robust Info (RI) |

The receiver packet formatter 240 processing is more clearly described by the following example. Consider a case with the following parameters: MODE=3, TR=0, NRS=1and NRP=54. TABLE 3 shows the ordering of the packets, at the input (I/P) to the transmitter packet formatter (T×PF), at the input (I/P) to receiver packet formatter 240 (R×PF), and at the output (O/P) of R×PF for this parameter set. In Table 3, “RI” indicates robust information packets, “RN” indicates NULL packets, “Std” indicates standard stream packets, and “Rob” indicates encoded robust packets. Packet 0 corresponds to the first packet after the field synchronization signal.

TABLE 3
Exemplary Packet Ordering for Selected Parameters
at Different Points in Transmitter and Receiver

| # | I/P to TxPF | I/P to RxPF | O/P of RxPF |
|---|---|---|---|
| 0 | RI 0 | Rob 0 | RN |
| 1 | Std 0 | Std 0 | Std 0 |
| 2 | Std 1 | Std 1 | Std 1 |
| 3 | Std 2 | Std 2 | Std 2 |
| 4 | RN | Rob 1 | RN |
| 5 | Std 3 | Std 3 | Std 3 |
| 6 | Std 4 | Std 4 | Std 4 |
| 7 | Std 5 | Std 5 | Std 5 |
| 8 | RI 1 | Rob 2 | RI 0 |
| 9 | Std 6 | Std 6 | Std 6 |
| 10 | Std 7 | Std 7 | Std 7 |
| 11 | Std 8 | Std 8 | Std 8 |
| 12 | RN | Rob 3 | RN |
| 13 | Std 9 | Std 9 | Std 9 |
| 14 | Std 10 | Std 10 | Std 10 |
| 15 | Std 11 | Std 11 | Std 11 |
| 16 | RI 2 | Rob 4 | RI 1 |
| 17 | Std 12 | Std 12 | Std 12 |
| 18 | Std 13 | Std 13 | Std 13 |
| 19 | Std 14 | Std 14 | Std 14 |
| 20 | RN | Rob 5 | RN |
| 21 | Std 15 | Std 15 | Std 15 |
| 22 | Std 16 | Std 16 | Std 16 |
| 23 | Std 17 | Std 17 | Std 17 |
| 24 | RI 3 | Rob 6 | RI 2 |
| 25 | Std 18 | Std 18 | Std 18 |
| 26 | Std 19 | Std 19 | Std 19 |
| 27 | Std 20 | Std 20 | Std 20 |
| 28 | RN | Rob 7 | RN |
| 29 | Std 21 | Std 21 | Std 21 |
| 30 | Std 22 | Std 22 | Std 22 |
| 31 | Std 23 | Std 23 | Std 23 |
| 32 | RN | Rob 8 | RI 3 |
| 33 | Std 24 | Std 24 | Std 24 |
| 34 | Std 25 | Std 25 | Std 25 |
| 35 | Std 26 | Std 26 | Std 26 |
| 36 | RI 4 | Rob 9 | RN |
| 37 | Std 27 | Std 27 | Std 27 |
| 38 | Std 28 | Std 28 | Std 28 |
| --- | --- | --- | --- |
| 71 | Std 54 | Std 54 | Std 54 |
| 72 | RI 8 | Rob 18 | RN |
| 72 | Std 55 | Std 55 | Std 55 |
| 74 | Std 56 | Std 56 | Std 56 |
| 75 | Std 57 | Std 57 | Std 57 |
| 76 | RN | Rob 19 | RN |
| --- | --- | --- | --- |
| 204 | RI 23 | Rob 51 | RI 22 |
| 205 | Std 153 | Std 153 | Std 153 |
| 206 | Std 154 | Std 154 | Std 154 |
| 207 | Std 155 | Std 155 | Std 155 |
| 208 | RN | Rob 52 | RN |
| 209 | Std 156 | Std 156 | Std 156 |
| 210 | Std 157 | Std 157 | Std 157 |
| 211 | Std 158 | Std 158 | Std 158 |
| 212 | RN | Rob 53 | RI 23 |
| 213 | Std 159 | Std 159 | Std 159 |
| 214 | Std 160 | Std 160 | Std 160 |
| 215 | Std 161 | Std 161 | Std 161 |
| 216 | Std 162 | Std 162 | Std 162 |
| 217 | Std 163 | Std 163 | Std 163 |
| 218 | Std 164 | Std 164 | Std 164 |
| 219 | Std 165 | Std 165 | Std 165 |
| 220 | Std 166 | Std 166 | Std 166 |
| 221 | Std 167 | Std 167 | Std 167 |
| 222 | Std 168 | Std 168 | Std 168 |
| 223 | Std 169 | Std 169 | Std 169 |
| --- | --- | --- | --- |
| 308 | Std 254 | Std 254 | Std 254 |
| 309 | Std 255 | Std 255 | Std 255 |
| 310 | Std 256 | Std 256 | Std 256 |
| 311 | Std 257 | Std 257 | Std 257 |

NRP=54 indicates that there are 54*4/9=24 RI packets and 54−24=30 RN packets in each field at the input to the T×PF. The T×PF formats the RI and RN packets to form the robust packets (referred to as “Rob”). The receiver receives these packets in the order shown in column “I/P to R×PF”. Since the information in RI 0 is spread into Rob 0, Rob 1 and Rob 2 packets, receiver packet formatter 240 must wait until it receives Rob 2 packet before it can recreate RI 0. Therefore, during the duration of Rob0 and Rob 1, packet formatter 240 sends out NULL (all zero) packets. Once receiver 200 gets the Rob 8 packet, receiver 200 can recreate RI3. This completes the process of converting 9 robust packets to 4 RI packets. Packet formatter 240 then starts processing the next group of robust packets. Column “O/P of R×PF” shows the order of the robust information packets at the output of packet formatter 240.

Receiver packet formatter 240 introduces a fixed delay of 2 robust packets in the robust information packets. The delay is variable in terms of the number of packets, since the inter-robust packet spacing is not fixed. TABLE 4 shows the delay for different NRP values. This display will affect the de-randomizer down the data path. The following sections describe a modified de-randomization scheme, which takes into account the delay introduced by the R×PF.

TABLE 4
Delay Introduced by Packet Formatter
240 For Different NRP Values

| NRP | Inter-robust packet spacing | Delay (packets) |
|---|---|---|
| 0000 | 0 | 0 |
| 0001 | 4 | 8 |
| 0010 | 4 | 8 |
| 0011 | 4 | 8 |
| 0100 | 4 | 8 |
| 0101 | 4 | 8 |
| 0110 | 4 | 8 |
| 0111 | 4 | 8 |
| 1000 | 4 | 8 |
| 1001 | 2 | 4 |
| 1010 | 2 | 4 |
| 1011 | 2 | 4 |
| 1100 | 1 | 2 |
| 1101 | 1 | 2 |
| 1110 | 1 | 2 |
| 1111 | 1 | 2 |

FIG. 5 is a logic diagram illustrating in greater detail robust de-interleaver 250 of 8-VSB receiver 200 according to an exemplary embodiment of the present invention. Robust de-interleaver 250 is a new signal processing block that processes only the bytes belonging to the robust stream. Robust de-interleaver 250 is similar in structure to a standard de-interleaver. Robust de-interleaver 250 comprises a convolutional de-interleaver with the number of rows equal to 69 and the size of the block equal to 3. In the example shown in FIG. 5, M=3, B=69 and N=207. Robust de-interleaver 250 receives data and control signals from packet formatter 240 via data path 295 and control signal path 288, respectively. Robust de-interleaver 250 only processes bytes belonging to robust information (RL) packets and delays (processing delay) appropriately all other bytes (belonging to the NULL packets and the SS). If the signal is encoded without a robust interleaver at the transmitter, then an option is provided to operate robust de-interleaver 250 in by-pass mode. Robust de-interleaver 250 introduces a variable amount of initial delay for the robust stream. This delay is dependent on the NRP parameter. Robust de-interleaver 250 uses the field synchronization and packet formatter 240 output control signals to synchronize to the first data byte of first RI packet in the field. As the robust interleaving is on top of the standard interleaving, the robust bit-stream has high error resilience to burst errors.

FIG. 6 is a block diagram illustrating in greater detail the robust de-interleaver 250 of 8-VSB receiver 250 according to an exemplary embodiment of the present invention. Robust de-interleaver 250 comprises de-multiplexer (De-MUX) 610, memory 620, multiplexer (MUX) 630, latency look-up table (LUT) 640, and generate start signal processing block 650. Robust de-interleaver 250 receives the data and the control signals from packet formatter 240 and sends out de-interleaved data and control signals to RS decoder 260. Robust de-interleaver 250 uses the ps_hd_sd control signal (control signal path 285) and the rob_pac_cnt control signal (control signal path 288) to de-multiplex the incoming data. The ps_hd_sd control signal determines if the incoming byte belongs to the new stream (NS) or to the standard stream (SS). The rob_pac_cnt control signal determines if the byte belongs to the RI packet or to the RN packet within the NS. Robust de-interleaver 250 sends the incoming data byte to memory 620 if the control signals indicate that the byte belongs to RI packet. Otherwise, the data is passed through unaltered. Multiplexer 630 uses the ps_hd_sd and rob_pac_cnt control signals to multiplex the RI packets, Std packets and RN packets. Multiplexer 630 reads data from memory 620 if the ps_hd_sd and rob_pac_cnt control signals indicate that the byte belongs to RI packet. Otherwise, multiplexer 630 reads data from the output of de-multiplexer 610.

Robust de-interleaver 250 must generate a signal to indicate the location of the first data byte of the first RI packet in a field. The location of the first RI data byte in a field depends on two factors: the robust interleaver size and the parameters TR, NRS and NRP. The robust interleaver size is fixed, resulting in fixed delay in terms of RI packets. This delay (in bytes) can be calculated as:
rd_size=3*((n−1)*n/2)*2,
where n=69. The delay can also be expressed in 207-byte packets as 68 RI packets.

The packet insertion mechanism in the new ATSC transmitter introduces a variable amount of delay between two successive RI packets depending on the TR, NRS and NRP parameters. Therefore, robust de-interleaver 250 also introduces a variable amount of delay between the field synchronization and the first RI data byte in terms of the actual number of packets (i.e. RI+Std+RN combined). This delay can be calculated by using the following algorithm:

Step 1: Let m be the inter-robust packet spacing (see TABLE 4) corresponding to the TR, NRS and NRP parameters. The value of m is 1, 2, or 4.

Step 2: Let NRI be the number of robust information packets in each field NRI=NRP*4/9.

Step 3: Calculate RI_dly as 68 mod NRI. This gives the number of the RI packets from the beginning of the field. This number can be offset by 2 to take into account the 2 robust packet delay (when TR=0, NRS=1) introduced by packet formatter 240.

Step 4: Use the value of RI_dly to determine the packet number in the field as:
init_dly=RI_delay*9*m/4.

The start signal 289 can be generated by generate start signal block 650 based on this initial delay value and it can be fly-wheeled to generate it every 312 packets as long as robust de-interleaver 250 is not reset. The init_dly values can be pre-computed and stored in latency look-up table (LUT) 640, as shown in FIG. 6. TABLE 5 shows the values for init_dly calculated using the above algorithm for different values of NRP, when TR=0 and NRS=1.

TABLE 5
Initial Delay (“Init_Delay”) Values for Different
NRP Values When TR = 0 and NRS = 1

| | | Number of | | | Offset from |
|---|---|---|---|---|---|
| | Number of | Robust | Inter-robust | | the Field |
| | Robust | Information | packet | | sync (in |
| | Packets in | Packets in | spacing | | packets) |
| NRP | each field | each field | (m) | RI_dly | (init_dly) |
| 0000 | 0 | 0 | 0 | 0 | 0 |
| 0001 | 9 | 4 | 4 | 0 | 0 |
| 0010 | 18 | 8 | 4 | 4 | 36 |
| 0011 | 27 | 12 | 4 | 8 | 72 |
| 0100 | 36 | 16 | 4 | 4 | 36 |
| 0101 | 45 | 20 | 4 | 8 | 72 |
| 0110 | 54 | 24 | 4 | 20 | 180 |
| 0111 | 63 | 28 | 4 | 12 | 108 |
| 1000 | 72 | 32 | 4 | 4 | 36 |
| 1001 | 90 | 40 | 2 | 28 | 126 |
| 1010 | 117 | 52 | 2 | 16 | 72 |
| 1011 | 144 | 64 | 2 | 4 | 18 |
| 1100 | 162 | 72 | 1 | 68 | 153 |
| 1101 | 171 | 76 | 1 | 68 | 153 |
| 1110 | 216 | 96 | 1 | 68 | 153 |
| 1111 | 270 | 120 | 1 | 68 | 153 |

RS decoder 260 in new receiver 200 produces two output start signals for de-randomizer 270 in order to start the standard de-randomizer circuitry and the robust de-randomizer circuitry at the correct instant. RS decoder 260 receives the data and the control signals from robust de-interleaver 250 and decodes all the packets (belonging to SS as well as NS). RS decoder 260 generates 187 byte data packets from 207 byte input data packets.

FIG. 7 illustrates in greater detail de-randomizer 270 of 8-VSB receiver 200 according to an exemplary embodiment of the present invention. De-randomizer 270 comprises standard de-randomizer 710, robust de-randomizer 720, multiplexer (MUX) 730, look-up table (LUT) 740, and generate freeze signal block 750. Standard de-randomizer 710 and robust de-randomizer 720 are structurally similar standard de-randomizers. Standard de-randomizer 710 is used to de-randomize the bytes corresponding to the standard stream (SS), while robust de-randomizer 720 is used to de-randomize the bytes corresponding to the new stream (NS). Standard de-randomizer 710 and robust de-randomizer 720 receive the same data input but different start signals from RS decoder 260. The output of standard de-randomizer 710 contains valid standard transport stream packets. The output of robust de-randomizer 720 contains valid robust transport stream packets. De-randomizer 270 can be programmed to give out the standard stream and/or the robust stream with NULL packets placed in the locations corresponding to the other stream.

De-randomizers 710 and 720 receive the error-corrected bytes from RS decoder 260 and de-randomizes the data using a pseudo-random binary sequence (PRBS). The PRBS is generated identically to that of the transmitter with similar feedback and output taps. The PRBS is generated by a 16-bit shift register with the following generator polynomial:
G₍₁₆₎=X¹⁶+X¹³+X¹²+X¹¹+X⁷+X⁶+X³+X+1.

The shift register is initialized to F180 hex and is synchronized with the field synchronization signal and the start signals. De-randomizers 710 and 720 perform modulo-2 addition of the incoming data byte with the de-randomizer byte (formed from bits D7 to D0). De-randomizers 710 and 720 operate without errors if the relative positions of the data bytes have not changed with respect to the field synchronization signal. Within a field, a data byte at a particular position in the field is always de-randomized by the same de-randomizing byte.

The inclusion of packet formatter 240 and robust de-interleaver 250 in new dual bit-stream receiver 200 introduces a delay in the NS data bytes. This delay is dependent on the parameters TR, NRS and NRP. Due to this delay, the relative position of the NS data bytes with respect to the field synchronization is changed. Therefore, a start signal has to be generated indicating the location of the first RI data byte in the field. Robust de-interleaver 250 generates this signal based on the algorithm described above. TABLE 6 shows the location of the first RI packet in the field for the case of TR=0 and NRS=1. The numbers in the column “Offset from the Field Sync” include the 2 robust packet delay introduced by receiver packet formatter 240.

TABLE 6
Location of First RI Packet In a Field for Different
NRP Values When TR = 0 and NRS = 1

| | Number of Robust Packets | Offset from the Field sync |
|---|---|---|
| NRP | in each field | (in packets) |
| 0000 | 0 | 0 |
| 0001 | 9 | 0 |
| 0010 | 18 | 44 |
| 0011 | 27 | 80 |
| 0100 | 36 | 44 |
| 0101 | 45 | 80 |
| 0110 | 54 | 188 |
| 0111 | 63 | 116 |
| 1000 | 72 | 44 |
| 1001 | 90 | 130 |
| 1010 | 117 | 76 |
| 1011 | 144 | 22 |
| 1100 | 162 | 155 |
| 1101 | 171 | 155 |
| 1110 | 216 | 155 |
| 1111 | 270 | 155 |

If the start signal is properly synchronized, then all the RI packets will be de-randomized correctly as long as the inter-robust packet spacing is the same. The packet insertion mechanism in the new ATSC transmitter does not meet this requirement for all values of NRP. In some cases, the spacing between the last packet of a field and the first packet of the next field is different from the inter-robust packet spacing (usually 1, 2 or 4). TABLE 7 shows this scenario for TR=0, NRS=1 and NRP=54. In this case, the inter-robust packet spacing is 4, but the spacing between the last packet of a field and the first packet of the next field is (312−212)=100 packets.

TABLE 7
Location (Field Number, Packet Number) of RI
Packets in Field at De-Randomizer Input for
TR = 0, NS = 1 and NRP = 54

| Packet # for | Robust |
|---|---|
| which hd_sd = 1 | packet number |
| P, 0 | RN |
| P, 4 | RN |
| P, 8 | P − 1, RI 4 |
| P, 12 | RN |
| P, 16 | P − 1, RI 5 |
| P, 20 | RN |
| P, 24 | P − 1, RI 6 |
| P, 28 | RN |
| P, 32 | P − 1, RI 7 |
| P, 36 | RN |
| P, 40 | RN |
| P, 44 | P − 1, RI 8 |
| P, 48 | RN |
| P, 52 | P − 1, RI 9 |
| P, 56 | RN |
| P, 60 | P − 1, RI 10 |
| P, 64 | RN |
| P, 68 | P − 1, RI 11 |
| P, 72 | RN |
| P, 76 | RN |
| P, 80 | P − 1, RI 12 |
| P, 84 | RN |
| P, 88 | P − 1, RI 13 |
| P, 92 | RN |
| P, 96 | P − 1, RI 14 |
| P, 100 | RN |
| P, 104 | P − 1, RI 15 |
| P, 108 | RN |
| P, 112 | RN |
| P, 116 | P − 1, RI 16 |
| P, 120 | RN |
| P, 124 | P − 1, RI 17 |
| P, 128 | RN |
| P, 132 | P − 1, RI 18 |
| P, 136 | RN |
| P, 140 | P − 1, RI 19 |
| P, 144 | RN |
| P, 148 | RN |
| P, 152 | P − 1, RI 20 |
| P, 156 | RN |
| P, 160 | P − 1, RI 21 |
| P, 164 | RN |
| P, 168 | P − 1, RI 22 |
| P, 172 | RN |
| P, 176 | P − 1, RI 23 |
| P, 180 | RN |
| P, 184 | RN |
| P, 188 | P, RI 0 |
| P, 192 | RN |
| P, 196 | P, RI 1 |
| P, 200 | RN |
| P, 204 | P, RI 2 |
| P, 208 | RN |
| P, 212 | P, RI 3 |
| P + 1, 0 | RN |
| P + 1, 4 | RN |
| P + 1, 8 | P, RI 4 |
| P + 1, 12 | RN |
| P + 1, 16 | P, RI 5 |
| P + 1, 20 | RN |
| P + 1, 24 | P, RI 6 |
| P + 1, 28 | RN |
| P + 1, 32 | P, RI 7 |
| P + 1, 36 | RN |
| P + 1, 40 | RN |
| P + 1, 44 | P, RI 8 |
| P + 1, 48 | RN |
| P + 1, 52 | P, RI 9 |
| P + 1, 56 | RN |
| P + 1, 60 | P, RI 10 |
| P + 1, 64 | RN |
| P + 1, 68 | P, RI 11 |
| P + 1, 72 | RN |
| P + 1, 76 | RN |
| P + 1, 80 | P, RI 12 |
| P + 1, 84 | RN |
| P + 1, 88 | P, RI 13 |
| P + 1, 92 | RN |
| P + 1, 96 | P, RI 14 |
| P + 1, 100 | RN |
| P + 1, 104 | P, RI 15 |

Consider the case of TR=0, NRS=1 and NRP=54. For this parameter set, robust de-interleaver 250 generates the start signal at packet number 188. TABLE 7 shows the field number and the packet number for RI packets. Due to the delay introduced by robust de-interleaver 250, packet RI 0 of field P appears at packet number 188 of field P. Robust de-randomizer 270 is reset at this point, so RI packets 0, 1, 2, and 3 will be de-randomized correctly. However, there is a discontinuity between RI packets 3 and 4 since RI 3 appears in the last robust packet position of field P and RI 4 appears in the 3^{rd} robust packet position of field P+1. During this period, de-randomizer 270 is still active and so it de-randomizes RI packets following RI 3 incorrectly. In order to avoid this kind of scenario, de-randomizer 270 is frozen for some duration of time by generate freeze signal processing block 750.

The duration and the position of the freeze are dependent on the TR, NRS and NRP parameters. The starting and ending positions of the freeze period can be determined by using the following algorithm:

Step 1: Let m be the inter-robust packet spacing corresponding to the TR, NRS and NRP parameters. The value of m is 1, 2 or 4.

Step 2: Let NRI be the number of robust information packets in each field NRI=NRP*4/9.

Step 3: Calculate RI_dly as 68 mod NRI. This gives the number of the RI packets from the beginning of the field. This number can be offset by 2 to take into account the 2 robust packet delay (when TR=0, NRS=1) introduced by packet formatter 240.

Step 4: Calculate ‘rem_rp’ as (NRI−RI_dly)

Step 5: If rem_rp<NRI, then go to Step 6. Otherwise, set start_count and end_count equal to 0.

Step 6: Calculate the starting point for the freeze as start_count=(rem_rp*9/4)*m−2*m.

Step 7: Calculate the end point for the freeze as end_count=(312−NRP*4)+start_count.

The start_count and end_count values can be pre-computed and stored in look-up table (LUT) 740. Generate freeze signal processing block 750 uses these two values from LUT 740 to generate the freeze signal. Generate freeze signal processing block 750 resets a packet counter on the start signal and increments this counter for each new packet that the generate freeze signal processing block 750 receives. If the packet counter is between the ‘start_count’ and the ‘end_count’, then robust de-randomizer 270 is frozen.

Only one freeze duration is required per field for the proposed packet insertion mechanism, but the logic can be extended to add additional freeze durations if required. After the freeze is released, de-randomizer 270 continues to operate until a start signal is received, at which point de-randomizer 270 is initialized. This ensures that all the RI packets are de-randomized correctly. TABLE 8 contains the ‘start_count’ and ‘end_count’ values as determined by the algorithm for the case of TR=0 and NRS=1.

TABLE 8
Start_Count and End_Count Values for Different
NRP Values When TR = 0 and NS = 1

| | start_count | end_count |
|---|---|---|
| NRP | (packets) | (packets) |
| 0000 | 0 | 0 |
| 0001 | 0 | 0 |
| 0010 | 28 | 268 |
| 0011 | 28 | 232 |
| 0100 | 100 | 268 |
| 0101 | 100 | 232 |
| 0110 | 28 | 124 |
| 0111 | 136 | 196 |
| 1000 | 244 | 268 |
| 1001 | 50 | 182 |
| 1010 | 158 | 236 |
| 1011 | 266 | 290 |
| 1100 | 7 | 157 |
| 1101 | 16 | 157 |
| 1110 | 61 | 157 |
| 1111 | 115 | 157 |

Standard de-randomizer 710 generates valid SS transport packets, while robust de-randomizer 720 generates valid NS transport packets. The two streams can be multiplexed in different configurations depending on user preferences. The operation of multiplexer 730 is controlled by a Select signal that is a combination of the hd_sd control signal, the rob_pac_cnt control signal, and a user adjustable output_sw control signal. Multiplexer 730 adds a 3-byte NULL header to the packets when the control signals hd_sd and rob_pac_cnt indicates a NULL packet. The source decoders discard the NULL packets.

Although the present invention has been described in detail, those skilled in the art will understand that various changes, substitutions, variations, enhancements, nuances, gradations, lesser forms, alterations, revisions, improvements and knock-offs of the invention disclosed herein may be made without departing from the spirit and scope of the invention in its broadest form.

1. A packet formatter (240) for use in a television receiver (200) capable of receiving a dual bitstream signal comprising a standard stream compatible with the Advanced Television Systems Committee (ATSC) standard and a robust stream, said packet formatter (240) comprising:
a first processing block (410) capable of receiving said dual bitstream signal and removing therefrom header bits and parity bits associated with said robust stream to thereby produce a first output signal; and
a second processing block (430) capable of receiving said first output signal and removing therefrom duplicate bits associated with said robust stream to thereby produce a second output signal that is output from a data path output (295) of said packet formatter (240).

2. The packet formatter (240) as set forth in claim 1 wherein said packet formatter (240) passes bytes associated with said standard stream to said data path output (295) of said packet formatter (240) after delaying said standard stream bytes by a predetermined delay time.

3. The packet formatter (240) as set forth in claim 2 wherein said packet formatter (240) comprises a third processing block (420) capable of determining the locations of said parity bits in said robust stream.

4. The packet formatter (240) as set forth in claim 3 wherein said third processing block (420) is further capable of determining the locations of said header bits in said robust stream.

5. The packet formatter (240) as set forth in claim 4 wherein said third processing block (420) comprises a look-up table (420).

6. The packet formatter (240) as set forth in claim 5 wherein said packet formatter (240) generates and outputs packet identification information used by subsequent processing blocks (250, 260, 270) following said packet formatter (240).

7. A signal comprising the second output signal output from the data path output of the packet formatter (240) as set forth in claim 1.

8. For use in a television receiver (200) capable of receiving a dual bitstream signal comprising a standard stream compatible with the Advanced Television Systems Committee (ATSC) standard and a robust stream, a method of formatting packets of said dual bitstream signal comprising the steps of:
receiving in a packet formatter (240) said dual bitstream signal and removing therefrom header bits and parity bits associated with said robust stream to thereby produce a first output signal; and
removing from said first output signal duplicate bits associated with said robust stream to thereby produce a second output signal that is output from a data path output (295) of said packet formatter (240).

9. The method as set forth in claim 8 further comprising the step of delaying bytes associated with said standard stream by a predetermined delay time before outputting said delayed standard stream bytes on said data path output (295) of said packet formatter (240).

10. The method as set forth in claim 9 further comprising the step of determining the locations of said parity bits in said robust stream.

11. The method as set forth in claim 10 further comprising the step of determining the locations of header bits in said robust stream.

12. The method as set forth in claim 11 wherein said step of determining the locations of said parity bits comprises the step of determining the locations of said parity bits from a look-up table (420).

13. The method as set forth in claim 12 further comprising the steps of generating and outputting packet identification information used by subsequent processing blocks (250, 260, 270) following said packet formatter (240).

14. A signal comprising the second output signal output from the data path output of the packet formatter (240) as set forth in claim 8.

15. A television receiver (200) comprising:
receiver front-end circuitry capable of receiving and down-converting a dual bitstream signal comprising a standard stream compatible with the Advanced Television Systems Committee (ATSC) standard and a robust stream to thereby produce a baseband signal; and
a forward error correction section capable of receiving said baseband signal from said receiver front-end circuitry, said forward error correction section comprising a packet formatter (240) comprising:
a first processing block (410) capable of receiving said standard stream and said robust stream associated with said baseband signal and removing therefrom header bits and parity bits associated with said robust stream to thereby produce a first output signal; and
a second processing block (430) capable of receiving said first output signal and removing therefrom duplicate bits associated with said robust stream to thereby produce a second output signal that is output from a data path output (295) of said packet formatter (240).

16. The television receiver (200) as set forth in claim 15 wherein said packet formatter (240) passes bytes associated with said standard stream to said data path output (295) of said packet formatter (240) after delaying said standard stream bytes by a predetermined delay time.

17. The television receiver (200) as set forth in claim 16 wherein said packet formatter (240) comprises a third processing block (420) capable of determining the locations of said parity bits in said robust stream.

18. The television receiver (200) as set forth in claim 17 wherein said third processing block (420) is further capable of determining the locations of said header bits in said robust stream.

19. The television receiver (200) as set forth in claim 18 wherein said third processing block (420) comprises a look-up table (420).

20. The television receiver (200) as set forth in claim 19 wherein said packet formatter (240) generates and outputs packet identification information used by subsequent processing blocks (250, 260, 270) following said packet formatter (240).

21. A data de-randomizer (270) for use in a television receiver (200) capable of receiving a dual bitstream signal comprising a standard stream compatible with the Advanced Television Systems Committee (ATSC) standard and a robust stream, said data de-randomizer (270) comprising:
a standard de-randomizer (710) capable of de-randomizing bytes associated with said standard stream; and
a robust de-randomizer (720) capable of de-randomizing bytes associated with said robust stream.

22. The data de-randomizer (270) as set forth in claim 21 wherein said data de-randomizer (270) further comprises a delay calculation circuit (740,750) for determining a delay with respect to a field synchronization signal associated with the robust stream.
